(19) United States
(12) Patent Application Publication
(10) Pub. No.: US 2008/0077914 A1
(43) Pub. Date: Mar. 27, 2008

(54) Driver installing method, driver controlling method and terminal apparatus

(75) Inventor: Keiichi Sando, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 11/902,431

(22) Filed: Sep. 21, 2007

(30) Foreign Application Priority Data
Sep. 22, 2006 (JP) 2006-257293

(51) Int. Cl. G06F 9/445

(52) U.S. Cl. 717/174

(57) ABSTRACT

A driver installing method is supplied capable of effectively installing driver program to correspond to respective modes of a device driven by the modes. The driver installing method is used to install respective driver programs corresponding to plural modes to a terminal apparatus in order to drive a device serving as peripheral equipment, and comprises steps of inputting device information for specifying said device; selecting said plural modes corresponding to said device on the basis of said device information; and collectively installing said respective driver program corresponding to said plural modes to said terminal apparatus.

### BACKGROUND OF THE INVENTION

1. Field of the Invention

The invention relates to a driver installing method to install a plurality of driver programs to a terminal apparatus for driving device serving as peripheral equipment; a driver controlling method to perform control of respective installed drivers; and a terminal apparatus in which the respective drivers are installed.

2. Related Background Art

In a print processing system constructed from terminal apparatus and printer serving as peripheral equipment connected with the terminal apparatus, in order to print manuscript data made by an application operating in the terminal apparatus through the printer, it is necessary to previously install printer driver to the terminal apparatus.

The printer driver is software for changing the manuscript data into printer language emulated by the printer; and is stored in a record medium such as CD-ROM and the like, together with a printer driver installer used for installing the printer driver to the terminal apparatus. An operator of the terminal apparatus puts the CD-ROM on a record medium reading unit provided in the terminal apparatus, and performs an input for making the installation of the printer driver start. Continuously, a setting scene for setting driver information is displayed on a displaying section of the terminal apparatus. The driver information is composed of plural item information including printer name or IP address or the like of the printer. Then, the operator performs inputs of respective item information via an inputting section. After that, when the printer driver is stored in a storing section of the terminal apparatus together with the inputted driver information, an installing process of the printer driver ends. Thus, it is possible to execute printing process via the printer driver.

In recent years, most of printers are mounted with emulation functions serving as plural modes so as to improve print process ability and image quality. In order to use respective emulations to execute print process, it is necessary to change the manuscript data through the different printer drivers. Therefore, in the terminal apparatus, plural printer drivers corresponding to respective emulations are installed.

Patent document 1: Japan patent publication H7-168282.

However, because such installing process is conventionally executed at every printer driver to correspond to respective emulations, in order to install the respective printer drivers to the terminal apparatus one be one, the operator must repeat installation work. Further, with every installation work, because the input of the above-stated driver information is necessary, the operator must input the same printer name and the same IP address any number of times, so it is very troublesome.

Furthermore, in the case to making the printer execute the print process, in order to specify the emulation to be used, the operator must select printer driver. In the emulation, there are some functions, for example, one function which is excellent for process ability of text data, one function which is suitable for graphic data function. Because of that, in the case not to perform an appropriate selection of printer driver, it is impossible to use an appropriate emulation. As a result, there are such problems that process speed or image quality can not be improved, and a desirable image can not be obtained.

Therefore, such driver installing method capable of effectively installing plural printer drivers corresponding to respective emulations to terminal apparatus and such driver controlling method capable of automatically selecting an appropriate printer driver and specifying it are desired.

### SUMMARY OF THE INVENTION

It is, therefore, an object of the invention to provide an image forming apparatus capable of solving the above problem.

According to the present invention, there is provided a driver installing method to install respective driver programs corresponding to plural modes to a terminal apparatus in order to drive a device serving as peripheral equipment, comprising steps of:

inputting device information for specifying the device;

selecting the plural modes corresponding to the device on the basis of the device information;

collectively installing the respective driver program corresponding to the plural modes to the terminal apparatus.

Further, according to the present invention, there is provided a terminal apparatus capable of installing respective driver programs corresponding to plural modes in order to drive a device serving as peripheral equipment, comprising:

an inputting section for inputting device information for specifying the device;

a selecting section for selecting the plural modes corresponding to the device on the basis of the device information; and

an installing section for collectively installing the respective driver program corresponding to the plural modes.

Further, according to the present invention, there is provided a driver controlling method for performing a control of respective drivers in a terminal apparatus in which the respective drivers are installed to correspond to plural emulations set in a printing apparatus, comprising steps of:

previously storing application identification information of application to correspond to emulation identification information of the emulation;

deciding application to make manuscript data;

selecting the emulation to correspond to the application and specifying driver corresponding to the emulation; and

changing the manuscript data into print data by the specified driver.

Furthermore, according to the present invention, there is provided a terminal apparatus in which respective drivers are installed to correspond to plural emulations set in a printing apparatus, comprising:

a storing section for previously storing application identification information of application to correspond to emulation identification information of the emulation;

a deciding section for deciding application to make manuscript data;

a searching and reading section for searching the storing section on the basis of the application identification information of the decided application, and reads out the corresponding emulation identification information;

a specifying section for specifying a corresponding driver on the basis of the read emulation identification information; and a changing section for changing the manuscript data into print data by the specified driver.

### EFFECT OF THE PRESENT INVENTION

According to the present invention, because device information of device driven in plural modes is previously inputted, and a plurality of driver programs corresponding to the respective modes are collectively installed to terminal apparatus, it becomes unnecessary to repeat the input of the device information any number of times, so that an installation work becomes efficient.

The above and other objects and features of the present invention will become apparent from the following detailed description and the appended claims with reference to the accompanying drawings.

### BRIEF DESCRIPTION OF THE DRAWINGS

FIG. 1 is a flowchart showing printer driver installation operation in embodiment 1 of a client PC of the present invention;

FIG. 2 is summary structure diagram of a print processing system;

FIG. 3 is a function block diagram concretely showing a structure of client PC in embodiment 1;

FIG. 4 is a function block diagram showing a function structure of client PC in embodiment 1;

FIG. 5 is an explanation diagram of a printer selection scene displayed on a displaying section of embodiment 1;

FIG. 6 is an explanation diagram of an emulation selection scene displayed on a displaying section of embodiment 1;

FIG. 7 is an explanation diagram of a print condition setting scene displayed on a displaying section of embodiment 1;

FIG. 8 is a structure diagram showing a driver information table of embodiment 1;

FIG. 9 is a structure diagram showing a print condition table of embodiment 1;

FIG. 10 is a structure diagram showing a printer information table of embodiment 1;

FIG. 11 is a flowchart showing print operation in embodiment 2 of a print processing system of the present invention;

FIG. 12 is a function block diagram showing a function structure of client PC in embodiment 2;

FIG. 13 is an explanation diagram of a switch setting scene displayed on a displaying section of embodiment 2;

FIG. 14 is a structure diagram showing a corresponding information table of embodiment 2;

FIG. 15 is a function block diagram showing a function structure of client PC in embodiment 3;

FIG. 16 is a first explanation diagram of a print condition setting scene displayed on a displaying section of embodiment 3;

FIG. 17 is a second explanation diagram of a print condition setting scene displayed on a displaying section of Embodiment 3

FIG. 18 is a structure diagram showing a print condition table of embodiment 3; and

FIG. 19 is a flowchart showing printer driver installation operation in embodiment 3 of a client PC of the present invention.

### DETAILED DESCRIPTION OF THE PREFERRED EMBODIMENTS

Embodiments of the invention will be described in detail hereinbelow with reference to the drawings.

Moreover, in the following embodiments, a printer will be explained as a device. The device is connected with a client PC as peripheral equipment. The client PC is a terminal apparatus. Further, not only the present invention can be applied to a printer, but also the present invention can be applied to various devices that can be used through installing driver to client PC, such as scanner, copying apparatus, facsimile apparatus, multiplex apparatus and the like.

### Embodiment 1

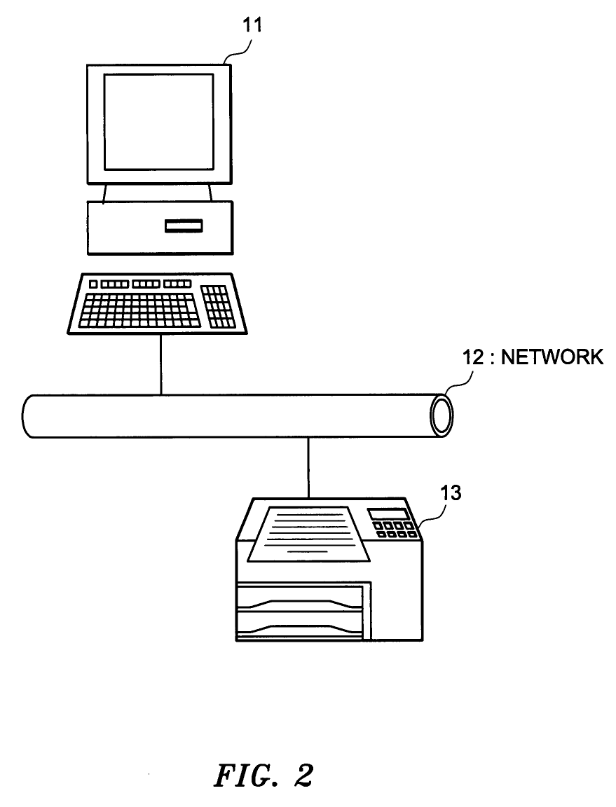

FIG. 2 is summary structure diagram of a print processing system.

A print processing system 10, as shown by the FIG. 2, comprises a client PC 11 as a terminal apparatus to perform a print request; and at least one printer 13 connected with the client PC 11 via a network 12. The printer 13 is a device serving as peripheral equipment of the client PC 11, and executes a print process on the basis of the print request outputted from the client PC 11.

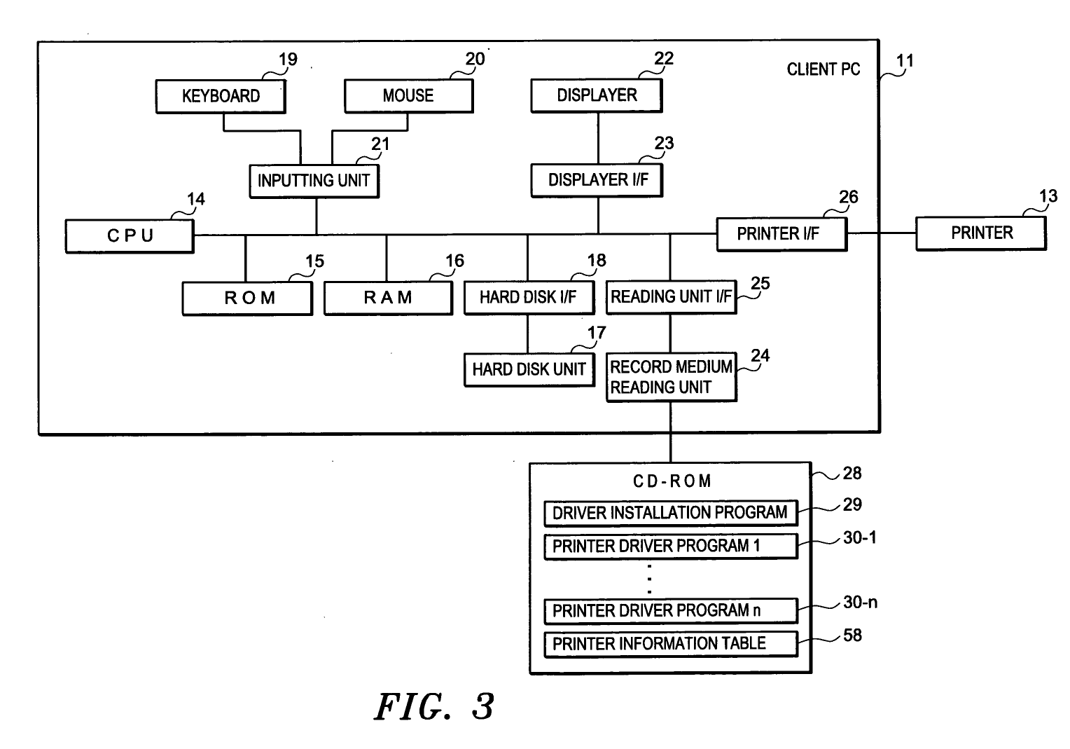

FIG. 3 is a function block diagram concretely showing a structure of client PC in embodiment 1.

The client PC 11 is composed of a personal computer in the embodiment. As shown by the FIG. 3, the client PC 11 includes a CPU 14, a ROM 15, a RAM 16, a hard disk unit 17, a hard disk I/F 18, a keyboard 19, a mouse 20, an inputting unit I/F 21, a displayer 22, a displayer I/F 23, a record medium reading unit 24, a reading unit I/F 25, and a printer I/F 26, they are connected each other via a bus 27.

The CPU 14 is a processing section to perform a united control of the client PC 11, and executes programs stored in the ROM 15 or the hard disk unit 17.

The ROM 15 stores program data (hereinafter: program) of control program such as BIOS and the like.

The RAM 16 has a function serving as a temporary storing section to temporarily store data, for example, is used as an operation area when respective programs are executed by the CPU 14.

The hard disk unit 17 is a storing section to store operating system program, various application programs or the like, and has a function to store driver installation program of the present invention. The hard disk unit 17 is connected with the hard disk I/F 18 via the bus 27.

The keyboard 19 and the mouse 20 are an inputting unit, for example, to input installation instruction information for instructing to start installation process of printer driver. The keyboard 19 and the mouse 20 are connected with the inputting unit I/F 21 via the bus 27.

The displayer 22 has a function as a displaying section to display various scenes including setting scene to set driver information and the like, and is connected with the displayer I/F 23 via the bus 27.

The record medium reading unit 24 is a reading unit which has a carry portion (not shown) for carrying an external storing medium such as CD-ROM 28 and the like, and executes a read process with respect to the external storing medium putted on the carry portion. The record medium reading unit 24 is connected with the reading unit I/F 25 via the bus 27.

The printer I/F 26 is an interface section which is composed of, for example, a network interface card or a parallel interface, and has a communication function to communicate with the printer 13 connected with the outside of the client PC 11.

The CD-ROM 28, as an external storing medium, is a program storing medium. In the CD-ROM 28, program data constructing driver installer, that is, driver installation program 29; respective program data constructing plural printer drivers, that is, printer driver program 30; and the like are stored. After the CD-ROM 28 is putted on the carry portion provided on the record medium reading unit 24 of the client PC 11, through the record medium reading unit 24, the driver installation program 29 is read.

The read driver installation program 29, after sent to the hard disk unit 17 and stored, is read out and executed by the CPU 14 for realizing the function serving as driver installer.

Further, in the CD-ROM 28, a printer information table 58 described below is stored. The printer information table 58 is read out together with the driver installation program 29, is sent to the hard disk unit 17 and is stored.

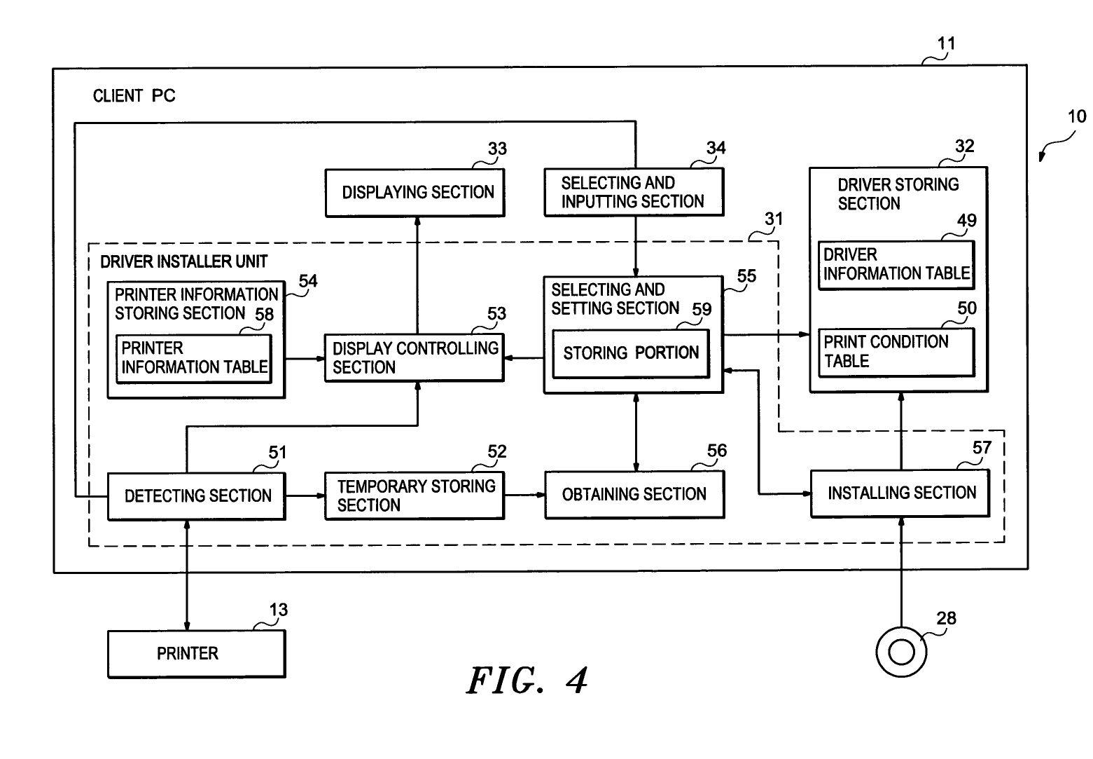

FIG. 4 is a function block diagram showing a function structure of client PC in embodiment 1.

In the client PC 11, the driver installation program 29 read from the CD-ROM 28 is executed so as to make the installation of the printer driver become possible.

As shown by the FIG. 4; the client PC 11 comprises a driver installer unit 31, a driver storing section 32, a displaying section 33 and a selecting and inputting section 34.

The displaying section 33 is used for displaying information; and the selecting and inputting section 34 is used for making operator perform a select or an input with respect to the displayed information (i.e. display information). Further, the selecting and inputting section 34 inputs installation instruction information for starting an installation process of printer driver, and sends the installation instruction information to a detecting section 51 that will be mentioned below.

The display information displayed by the displaying section 33 is printer names and the like of respective printers connected with the network 12, in the case, operator may select one from the printers. Moreover, the printer name may be printer name information stored in the CD-ROM 28.

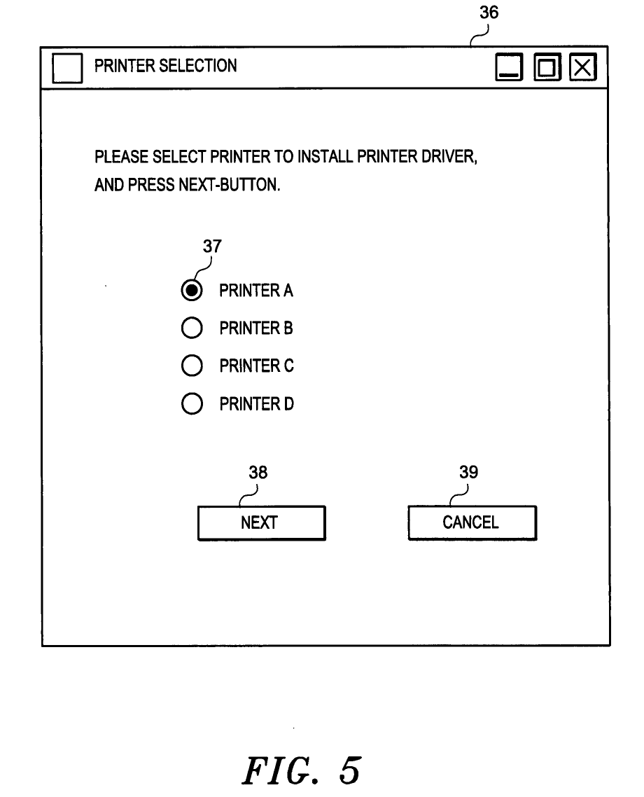

FIG. 5 is an explanation diagram of a printer selection scene displayed on a displaying section of embodiment 1.

On a printer selection scene 36, as shown by the FIG. 5, printer names are displayed, and a selection button 37 is provided to correspond to the printer names. Further, on the printer selection scene 36, a “NEXT” button 38 for deciding a selection and entering next scene, and a “CANCEL” button 39 for canceling selection are respectively provided.

Through using the printer selection scene 36, operator may select a desirable printer when an installation process of printer driver is performed. After the operator performed an selection, the selecting and inputting section 34 shown by FIG. 4 outputs corresponding information to a selecting and setting section 55 that will be mentioned below, as selection printer information.

Further, the display information displayed by the displaying section 33 is emulation names of respective emulations to correspond to the printer selected in the printer selection scene 36. In the case, operator may select one or more from the emulations. Here, the emulation selected in the client PC 11 is to serve as a mode of the printer.

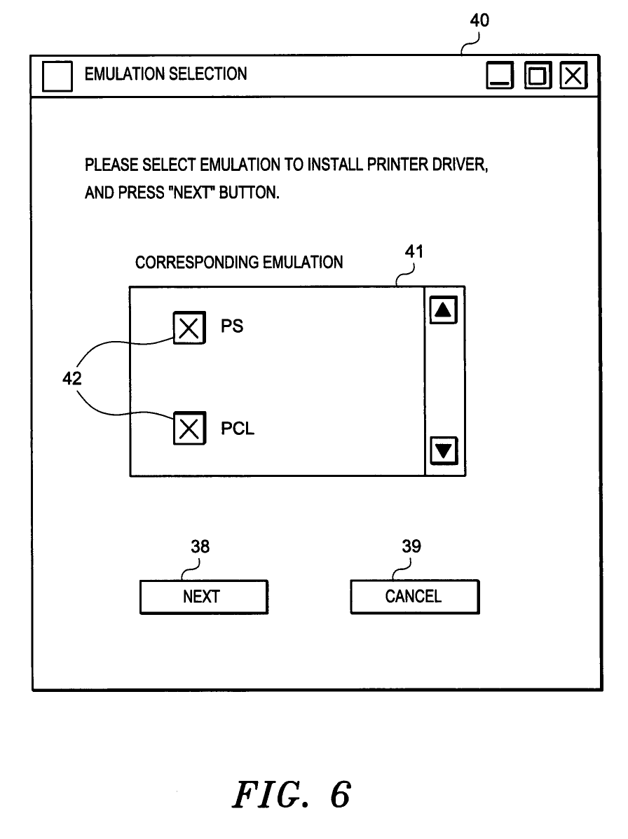

FIG. 6 is an explanation diagram of an emulation selection scene displayed on a displaying section of embodiment 1.

On an emulation selection scene 40, as shown by the FIG. 6, a list box 41 is provided to display a list of emulation that can be used by the printer 13 selected in the printer selection scene 36 (FIG. 5). In the list box 41, a selection button 42 is provided to correspond to the respective emulations. Further, on the emulation selection scene 40, a “NEXT” button 38 and a “CANCEL” button 39 are respectively displayed.

Through using the emulation selection scene 40, operator may select one emulation or more than two emulations to install printer driver. After the operator performed an selection, the selecting and inputting section 34 shown by FIG. 4 outputs corresponding information to a selecting and setting section 55 that will be mentioned below, as selection emulation information.

Furthermore, the display information displayed by the displaying section 33 is print condition information of respective printer drivers. In the case, operator may set the print condition information of printer driver corresponding to the displayed emulation.

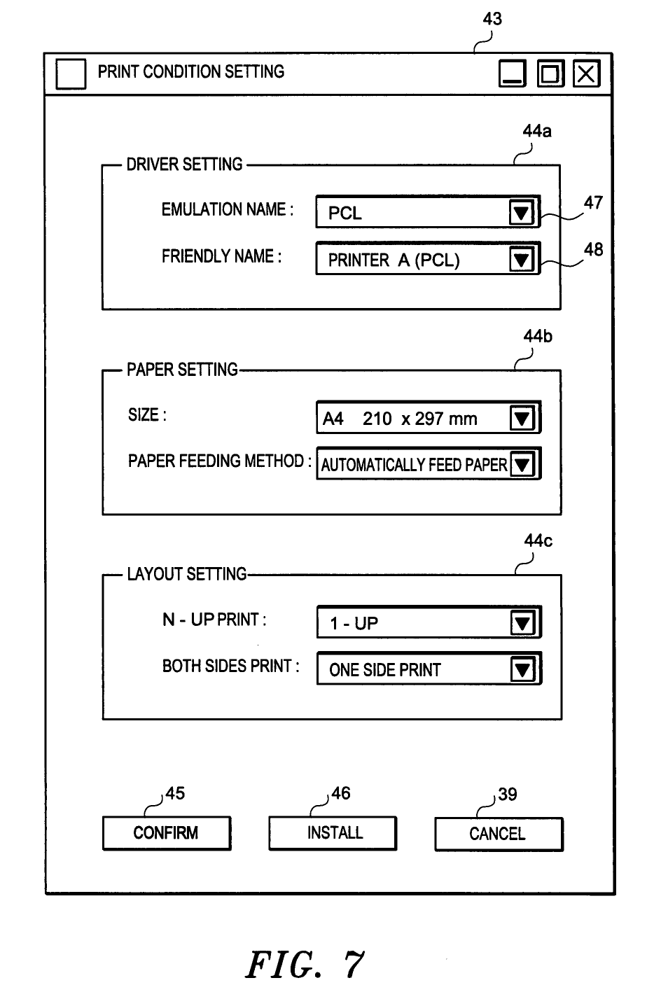

FIG. 7 is an explanation diagram of a print condition setting scene displayed on a displaying section of embodiment 1.

A print condition setting scene 43, as shown by the FIG. 7, has three parts 44a, 44b and 44c. In these parts, respective item information such as emulation name, paper size, paper feeding method, print mode and the like are displayed. Further, on the print condition setting scene 43, a “CONFIRM” button 45 for confirming setting, an “INSTALL” button 46 for executing an installation of printer driver and a “CANCEL” button 39 are provided.

In the print condition setting scene 43, the part 44a is furnished for setting name of printer driver displayed on the displaying section 33 as friendly name; and has a drop down list box 47 capable of displaying a list of emulation, and an edit box 48. In the drop down list box 47, emulation names of respective emulations selected in the emulation selection scene 40 (FIG. 6) are displayed one by one according to selection of operator. Then, with respect to the respective emulations displayed in the drop down list box 47, operator may input any friendly name to the edit box 48.

Further, in the print condition setting scene 43, the part 44b is a part to select paper size and paper feeding method; the part 44c is a part to select layout type and print mode. In The respective item information, each contains plural elements, for example, operator may select the respective item information such as “A4” serving as paper size; “AUTOMATICALLY FEED PAPER” serving as paper feeding method; “1-UP” serving as layout type; “ONE SIDE PRINT” serving as print mode; and the like.

After the operator performed input and selection with respect to these item information, the selecting and inputting section 34 shown by FIG. 4 outputs corresponding item information to a selecting and setting section 55 that will be mentioned below, as print condition information.

Moreover, in the embodiment, though the print condition information set in print condition setting scene 43 consists of respective item information of friendly name, paper size, paper feeding method, layout type and print mode, however, it is not limited in that, for example, it also may contain other item information such as paper thickness information to specify a thickness of paper; print range information to specify a range of print; print circulation information to specify a circulation of print; print quality information to specify a quality of print; watermark information to indicate whether watermark exists or indicate shape of watermark; print color information to indicate monochrome print or color print; and the like.

The driver storing section 32 is a storing section to store the printer driver program 30 constructing printer driver installed by the driver installer unit 31, driver information, print condition information and the like. As shown by the FIG. 4, the driver storing section 32 includes a driver information table 49 and a print condition table 50.

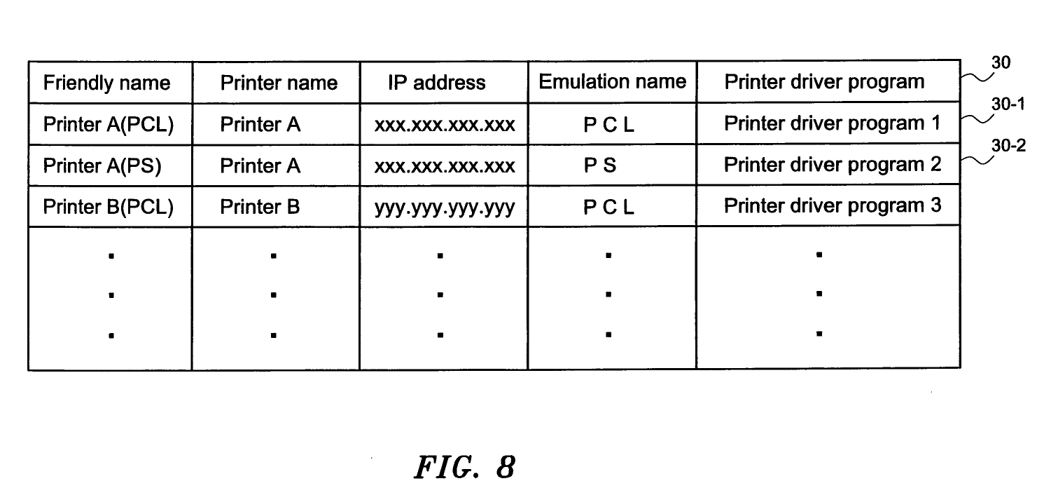

FIG. 8 is a structure diagram showing a driver information table of embodiment 1.

In the driver information table 49, as shown by the FIG. 8, driver information is stored to correspond to each printer driver. Further, in the embodiment, as printer driver ID for identifying printer driver, the friendly name that is set in the print condition setting scene 43 (FIG. 7) and serves as name of printer driver is stored in the driver information table 49.

The driver information stored in the driver information table 49 is composed of a printer name and an IP address of the printer 13 controlled by printer driver; and corresponding emulation name. Further, in the driver information table 49, the printer driver program 30 to construct printer driver is stored.

Moreover, it is also possible to provide a particular storing section to store the printer driver program 30. Then, in the driver information table 49, it is fine to only store an address indicating the storing place of the printer driver program 30.

In the driver information table 49 shown by the FIG. 8, on one hand, for example, to correspond to the friendly name “Printer A(PCL)”, a printer name “Printer A” and an IP address “xxx.xxx.xxx.xxx” are stored; further, as emulation corresponding to printer driver, an emulation name “PCL” is stored; furthermore, printer driver program “printer driver program 1” is stored.

On the other hand, to correspond to the friendly name “Printer A(PS)”, a printer name “Printer A”, an IP address “xxx.xxx.xxx.xxx” and an emulation name “PS” are stored; further, to correspond to these, printer driver program “printer driver program 2” is stored.

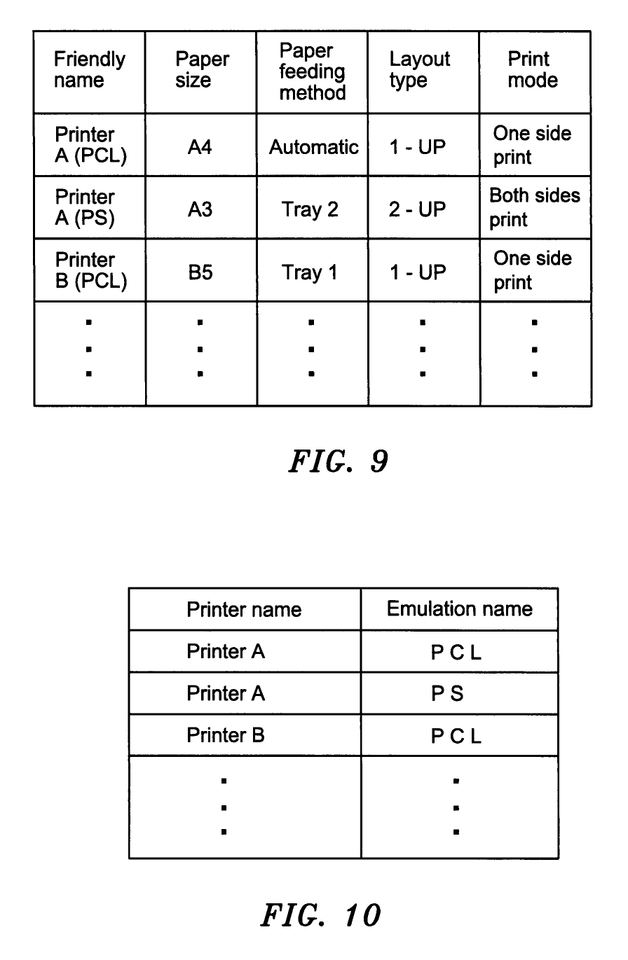

FIG. 9 is a structure diagram showing a print condition table of embodiment 1.

In the print condition table 50, as shown by the FIG. 9, print condition information of each printer driver is stored to correspond to friendly name serving as printer driver ID.

In the embodiment, the print condition information stored in the print condition table 50 is composed of respective item information of paper size, paper feeding method, layout type and print mode. However, it is not limited in these, it also may contain other item information, that is, respective information capable of being set in the print condition setting scene 43 (FIG. 7), for example, paper thickness information; print range information; print circulation information; print quality information; watermark information; print color information; and the like.

For example, in the print condition table 50 shown by FIG. 9, to correspond to the friendly name of “Printer A(PCL)”, paper size “A4”; paper feeding method “Automatic”; layout type “1-UP”; and print mode “One side print” are stored.

Further, to correspond to the friendly name of “Printer A(PS)”, paper size “A3”; paper feeding method “Tray 2”; layout type “2-UP”; and print mode “Both sides print” are stored.

In order to install respective printer drivers, the driver installer unit 31, as a printer driver installer, includes a detecting section 51; a temporary storing section 52; a display controlling section 53; a printer information storing section 54; a selecting and setting section 55, an obtaining section 56; and an installing section 57.

The respective functions of the driver installer unit 31 are realized through the CPU 14, the RAM 16, the hard disk unit 17, the hard disk I/F 18, the displayer I/F 23, the record medium reading unit 24, the reading unit I/F 25 and the printer I/F 26.

The detecting section 51 broadcasts printer inquiry information in order to detect printer connected with the network 12 according to an installation instruction information inputted by the selecting and inputting section 34; and when received a response information from the printer 13, notifies the display controlling section 53 of the receiving of the response information. Moreover, the response information contains driver information such as printer name, IP address and the like of the printer 13; is sent to the temporary storing section 52 by the detecting section 51 and is stored.

The display controlling section 53 has a function to control the displaying section 33 to display respective scenes. For example, when a receiving of the response information is notified by the detecting section 51, the display controlling section 53 reads out the printer name contained in the response information from the temporary storing section 52; and has the displaying section 33 display the printer selection scene 36 (FIG. 5) containing the printer name. Further, when a printer name selected by the selecting and setting section 55 mentioned below is notified, the display controlling section 53 reads out the emulation name corresponding to the printer name from the printer information storing section 54; and has the displaying section 33 display the emulation selection scene 40 (FIG. 6) containing the emulation name.

The printer information storing section 54 stores a printer information table 58 relative to plural printers. In the embodiment, the printer information table 58 stored in the printer information storing section 54 is previously reads from the CD-ROM 28 together with the driver installation program 29, then is stored. But it is not limited in that, for example, it may be generated on the basis of information obtained from printers connected to network.

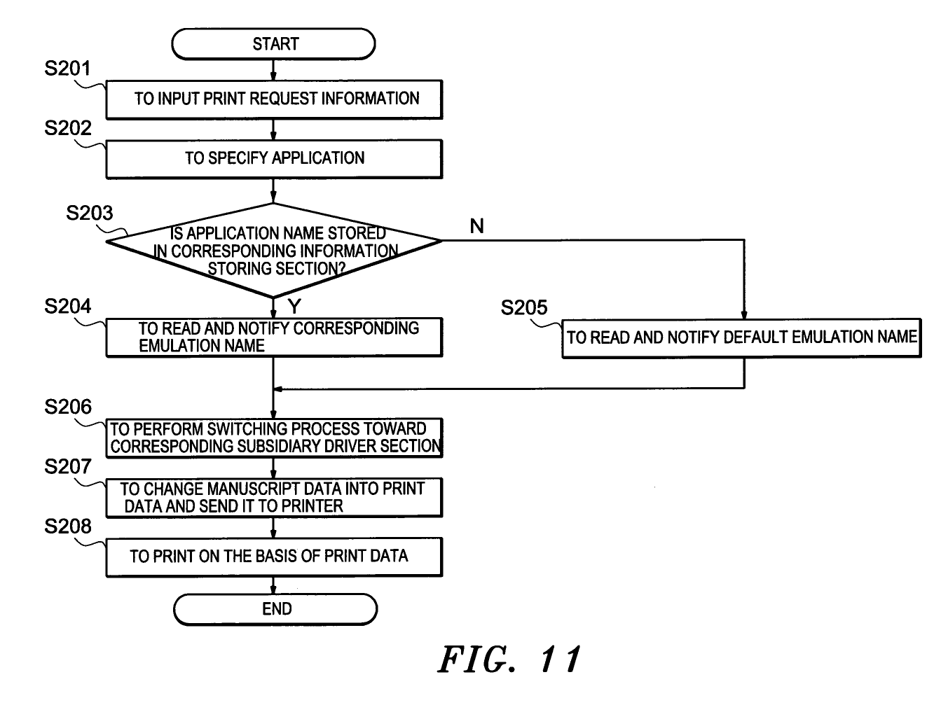

FIG. 10 is a structure diagram showing a printer information table of embodiment 1.

In the printer information table 58, as shown by the FIG. 10, to correspond to every printer, a printer name of the printer and an emulation name of emulation supported by the printer are respectively stored. The printer name stored in the printer information table 58 is printer identification information to identify the printer. The printer identification information is previously held in the printer, in the embodiment, it is model name of the printer.

In the printer information table 58 shown by the FIG. 10, for example, to correspond to the printer name of “Printer A”, emulation names of “PCL” and “PS” are stored. That is, the printer called “Printer A” is a printer capable of being controlled by two modes, so the printer can execute print processes to respectively use emulations “PCL” and “PC” to correspond to the two modes.

The selecting and setting section 55 is a processing section to perform settings of driver information and print condition information to correspond to respective printer drivers and to have the driver storing section 32 store the driver information and the print condition information, the selecting and setting section 55 has a storing portion 59. The storing portion 59 is a temporary storing portion to temporarily store the driver information and the print condition information inputted by the selecting and inputting section 34.

The selecting and setting section 55 selects a printer according to the selection printer information received from the selecting and inputting section 34, and has the driver information table 49 of the driver storing section 32 store the printer name serving as printer identification information corresponding to the printer. Then, the selecting and setting section 55 notifies the obtaining section 56 of the printer name.

Further, the selecting and setting section 55 selects an emulation according to the selection emulation information received from the selecting and inputting section 34, and has the driver information table 49 store the emulation name serving as emulation identification information corresponding to the emulation.

Furthermore, according to the print condition information received from the selecting and inputting section 34, the selecting and setting section 55 not only sets the friendly name and has the driver information table 49 store the friendly name, but also has the print condition table 50 store the respective item information of the paper size, the paper feeding method, the layout type and the print mode. Then, the selecting and setting section 55 notifies the installing section 57 of the selection printer information and the selection emulation information for installing printer driver.

The obtaining section 56 has function to read and obtain the corresponding IP address from the temporary storing section 52 on the basis of the printer name notified by the selecting and setting section 55, and to send the IP address to the selecting and setting section 55.

The installing section 57 is a processing section to read out the printer driver program 30 constructing the corresponding printer driver from the CD-ROM 28 on the basis of the selection printer information and the selection emulation information notified from the selecting and setting section 55, and to have the driver storing section 32 store the selection printer information and the selection emulation information.

The printer 13 supports the emulations “PCL” and “PS” as two modes, and has a printer name of “Printer A” as printer identification information. The printer 13, when received the printer inquiry information from the client PC 11, generates response information including driver information composed of the printer name and the IP address of “xxx.xxx.xxx.xxx”, and sends them to the client PC 11. Moreover, the driver information may further includes information relative of emulation supported by the printer except the printer name and the IP address.

The following is to explain in detail installation process in the client PC 11 to install printer driver from the CD-ROM 28 according to a flowchart.

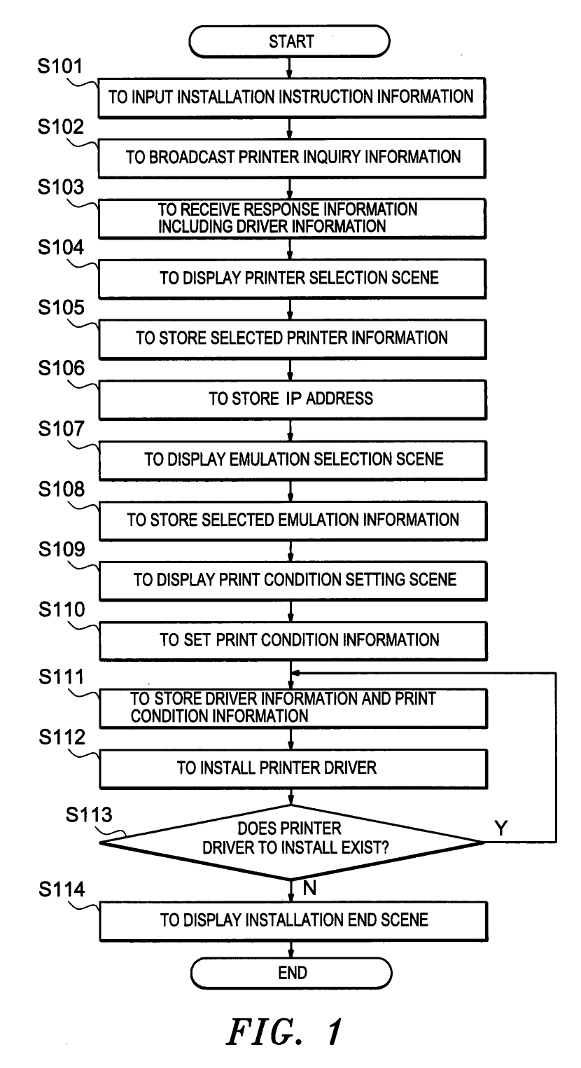

FIG. 1 is a flowchart showing printer driver installation operation in embodiment 1 of a client PC of the present invention.

In the client PC 11, the driver installation program 29 stored in the hard disk unit 17 is executed, and the installation instruction information to instruct a start of installation process of printer driver is inputted by the selecting and inputting section 34 (S101). Then, the detecting section 51 broadcasts the printer inquiry information for detecting printer with respect to the network 12 (S102).

The printer 13 receives the printer inquiry information outputted from the client PC 11, and sends response information including driver information composed of the printer name of “Printer A” and the IP address of “xxx.xxx.xxx.xxx” of the printer 13 to the client PC 11.

In the client PC 11, the detecting section 51 receives the response information including the driver information from the printer 13 (S103), then the response information is stored in the temporary storing section 52. Continuously, after the detecting section 51 notifies the display controlling section 53 of the receiving of the response information, the display controlling section 53 controls the displaying section 33 to display the printer selection scene 36 (FIG. 5) (S104).

In the printer selection scene 36, the printer names contained in the response information coming from the respective detected printers are respectively displayed. In the printer selection scene 36, when the selection button 37 is selected to correspond to the printer 13 whose printer name is “Printer A” and the “NEXT” button 38 is pressed, the selecting and inputting section 34 outputs the printer name of “Printer A” corresponding to the printer 13 to the selecting and setting section 55 as the selection printer information. The selecting and setting section 55 receives the selection printer information from the selecting and inputting section 34 and stores the printer name of “Printer A” into the storing portion 59 (S105).

Continuously, the selecting and setting section 55 notifies the obtaining section 56 of the printer name of “Printer A”. The obtaining section 56 receives the notification; reads out the IP address of “xxx.xxx.xxx.xxx” from the response information corresponding to the printer name of “Printer A” stored in the temporary storing section 52 to obtain the IP address; and sends the IP address to the selecting and setting section 55. The selecting and setting section 55 stores the IP address of “xxx.xxx.xxx.xxx” into the storing portion 59 (S106).

Next, the selecting and setting section 55 notifies the display controlling section 53 of the printer name of “Printer A”. The display controlling section 53 receives the notification and reads out the emulation names of “PCL” and “PS” corresponding the printer name of “Printer A” from the printer information table 58 of the printer information storing section 54. Then, the display controlling section 53 controls the displaying section 33 to display the emulation selection scene 40 (FIG. 6) on the basis of the emulation names of “PCL” and “PS” (S107). The displaying section 33 reads out the scene information of the emulation selection scene 40 from a scene information storing section (not shown), and displays the emulation selection scene 40 containing the selection buttons 42 to respectively correspond to the notified emulation names of “PCL” and “PS”.

In the emulation selection scene 40, when one or both of the respective selection buttons 42 corresponding to the emulation names of “PCL” and “PS” is/are selected, and the “NEXT” button 38 is pressed, the selecting and inputting section 34 outputs the emulation name corresponding to the selected selection button 42 to the selecting and setting section 55 as the selection emulation information. The selecting and setting section 55 receives the selection emulation information coming from the selecting and inputting section 34 and stores the emulation name into the storing portion 59 (S108). For example, in the emulation selection scene 40, in the case that the respective selection buttons 42 corresponding to the emulation names of “PCL” and “PS” are all selected, the emulation names of “PCL” and “PS” are outputted to the selecting and setting section 55 as the selection emulation information and are stored into the storing portion 59.

Continuously, the selecting and setting section 55 notifies the display controlling section 53 of the selection emulation information. The display controlling section 53 receives the notification and controls the displaying section 33 to display the print condition setting scene 43 (FIG. 7) on the basis of the selection emulation information (S109). For example, when the emulation names of “PCL” and “PS” are notified to the display controlling section 53 as the selection emulation information, the displaying section 33 reads out the scene information of the print condition setting scene 43 from a scene information storing section (not shown), and displays the print condition setting scene 43 enabling the drop down list box 47 to display the notified emulation names of “PCL” and “PS”.

Through using the print condition setting scene 43, operator inputs friendly name in the edit box 48 to correspond to the selection emulation information in the drop down list box 47, then respectively selects and sets the paper size, the paper feeding method, the layout type and the print mode (S110). When the “CONFIRM” button 45 is pressed, the selecting and inputting section 34 outputs the respective item information of the friendly name, the paper size, the paper feeding method, the layout type and the print mode that serve as print condition information to the selecting and setting section 55 together with the emulation name. The selecting and setting section 55 receives an input of the selecting and inputting section 34, and stores the respective item information of the print condition information into the storing portion 59 to correspond to the emulation name.

For example, in the print condition setting scene 43, in the state that the emulation name of “PCL” is displayed in the drop down list box 47, when the friendly name of “PRINTER A (PCL)” is inputted; the paper size of “A4”, the paper feeding method of “AUTOMATICALLY FEED PAPER”, the layout type of “1-UP” and the print mode of “ONE SIDE PRINT” are selected and set; and the “CONFIRM” button 45 is pressed, the selecting and setting section 55 stores the respective item information of the friendly name of “PRINTER A (PCL)”, the paper size of “A4”, the paper feeding method of “AUTOMATICALLY FEED PAPER”, the layout type of “1-UP” and the print mode of “ONE SIDE PRINT” into the storing portion 59 as the print condition information to correspond to the emulation name of “PCL”.

Likewise, in the state that the emulation name of “PS” is displayed in the drop down list box 47, when the friendly name of “PRINTER A (PS)” is inputted; the paper size of “A3”, the paper feeding method of “TRAY 2”, the layout type of “2-UP” and the print mode of “BOTH SIDES PRINT” are selected and set; and the “CONFIRM” button 45 is pressed, the selecting and setting section 55 stores the respective item information of the friendly name of “PRINTER A (PS)”, the paper size of “A3”, the paper feeding method of “TRAY 2”, the layout type of “2-UP” and the print mode of “BOTH SIDES PRINT” into the storing portion 59 as the print condition information to correspond to the emulation name of “PS”.

After the print condition information is set with respect to the respective emulations (S110), when the “INSTALL” button 46 is pressed in the print condition setting scene 43, the selecting and setting section 55 receives the input of the selecting and inputting section 34 and has the driver storing section 32 store the driver information and the print condition information corresponding the friendly name of “PRINTER A (PCL)” stored in the storing portion 59 (S111). That is, the selecting and setting section 55 has the driver information table 49 store the printer name of “Printer A”, the IP address of “xxx.xxx.xxx.xxx” and the emulation name of “PCL” together with the friendly name of “PRINTER A (PCL)”; further has the print condition table 50 store the paper size of “A4”, the paper feeding method of “AUTOMATICALLY FEED PAPER”, the layout type of “1-UP” and the print mode of “ONE SIDE PRINT” together with the friendly name of “PRINTER A (PCL)”.

When the driver information and the print condition information are stored, the selecting and setting section 55 notifies the installing section 57 of the printer name of “Printer A” serving as the selection printer information for installing printer driver corresponding to the friendly name of “PRINTER A (PCL)”; and of the emulation name of “PCL” serving as the selection emulation information. Then, the installing section 57 receives the notification and installs the corresponding printer driver (S112). That is, the installing section 57 reads out the printer driver program 30-1 corresponding to the printer name of “Printer A” and the emulation name of “PCL” from the CD-ROM 28 and stores it into the driver information table 49 of the driver storing section 32. When the installation ended, the installing section 57 notifies the selecting and setting section 55 of the end of installation.

The selecting and setting section 55, when received the notification of the end of installation, deletes the driver information and the print condition information relative to the installed printer driver from the storing portion 59. After that, the selecting and setting section 55 judges whether un-installed printer driver exists (S113). The selecting and setting section 55 judges the existence or inexistence of the un-installed printer driver through judging whether there are the driver information and the print condition information storing in the storing portion 59. In the case that the un-installed printer driver exists, the selecting and setting section 55 makes the driver storing section 32 store the driver information and the print condition information relative to the printer driver (S111). That is, the selecting and setting section 55 has the driver information table 49 store the printer name of “Printer A”, the IP address of “xxx.xxx.xxx.xxx” and the emulation name of “PS” together with the friendly name of “PRINTER A (PS)”; further has the print condition table 50 store the paper size of “A3”, the paper feeding method of “TRAY 2”, the layout type of “2-UP” and the print mode of “BOTH SIDES PRINT” together with the friendly name of “PRINTER A (PS)”.

Then, by the selecting and setting section 55, the installing section 57, after received the notification of the printer name of “Printer A” and the emulation name of “PS”, installs the corresponding printer driver program 30-2 (S112).

When an end of installation is notified from the installing section 57, The selecting and setting section 55 deletes the driver information and the print condition information relative to the installed printer driver from the storing portion 59. Then, the selecting and setting section 55 judges whether un-installed printer driver exists (S113). In the case that the un-installed printer driver does not exist, the selecting and setting section 55 notifies the display controlling section 53 of an end of the installation process. Then, the display controlling section 53 makes the displaying section 33 display an installation end scene for displaying the end of installation process (S114). Thereby, the installation process ended.

As stated above, after the printer name of “Printer A” and the IP address of “xxx.xxx.xxx.xxx” are obtained from the printer in which plural emulations are mounted, plural printer drivers corresponding to the respective emulations are sequentially installed to the client PC 11.

Moreover, after the installation process ended, according to necessity, it is possible to further provide a restarting section for restarting into the client PC 11. In the case, the selecting and setting section 55 notifies the restarting section of the end of installation process. Then, the restarting section, after received the notification, judges whether the restarting is necessary, if it is necessary, executes the restarting. Then the display controlling section 53 receives a notification from the restarting section and makes the displaying section 33 display a restarting scene.

As stated above, the client PC 11 in the embodiment, after obtained the printer name of “Printer A” and the IP address of “xxx.xxx.xxx.xxx” from the printer in which plural emulations are mounted, can collectively install plural printer drivers corresponding to the respective emulations on the basis of the printer name of “Printer A” and the IP address of “xxx.xxx.xxx.xxx”. Therefore, the detection of printer and the input of the printer name an the IP address does not need to repeat any number of times, so that work becomes efficient. Further, because the setting of print condition becomes possible together with installing the respective printer drivers, the efficiency of installation can be improved.

### Embodiment 2

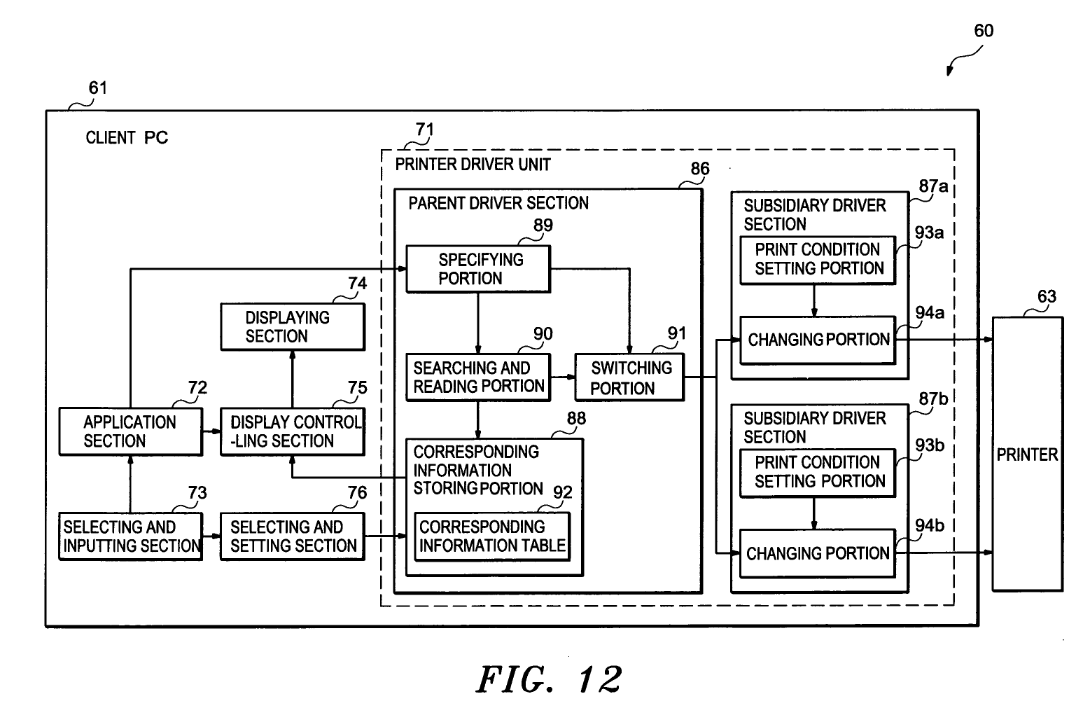

FIG. 12 is a function block diagram concretely showing a function structure of client PC in embodiment 2.

In the embodiment 2, a client PC 61 is connected with a printer 63 via network, and constructs a print processing system 60 together with the printer 63.

The printer 63 is mounted with emulations as plural modes. In the embodiment, two emulations of “PCL” and “PS” are mounted in the printer 63.

In the client PC 61 shown by the FIG. 12, respective printer drivers corresponding to the respective emulations of “PCL” and “PS” mounted in the printer 63 are previously installed; and print processes to use the respective emulations are in executable state.

As shown by the FIG. 12, the client PC 61 includes a printer driver unit 71, an application section 72, a selecting and inputting section 73, a displaying section 74, a display controlling section 75, and a selecting and setting section 76.

The application section 72 is a processing section to perform, for example, a make, a reading and an edit of manuscript, and contains plural applications. The application section 72 performs respective processes on the basis of an input of the selecting and inputting section 73 and notifies operator of a result of process via the displaying section 74. Further, as stated below, when a print instruction information to instruct a start of print process is inputted via the selecting and inputting section 73, the application section 72 sends print request information indicating a print request to the printer driver unit 71 via a GDI (Graphics Device Interface, not shown). In the print request information sent to the printer driver unit 71 by the application section 72, not only manuscript data of the manuscript to print, but also an application name serving as application identification information to identify application are contained.

The displaying section 74 is used for displaying information; and the selecting and inputting section 73 is used for making operator perform a select or an input with respect to the displayed information (i.e. display information). Further, the selecting and inputting section 73 inputs a print instruction information for starting a print process, and sends the print instruction information to the application section 72.

The display information displayed by the displaying section 74 is emulation names serving as emulation identification information and the like of respective emulations to correspond to printer drivers installed in the client PC 61. In the case, operator may select one emulation used for the print of manuscript made by the application from the displayed plural emulation names and may register it.

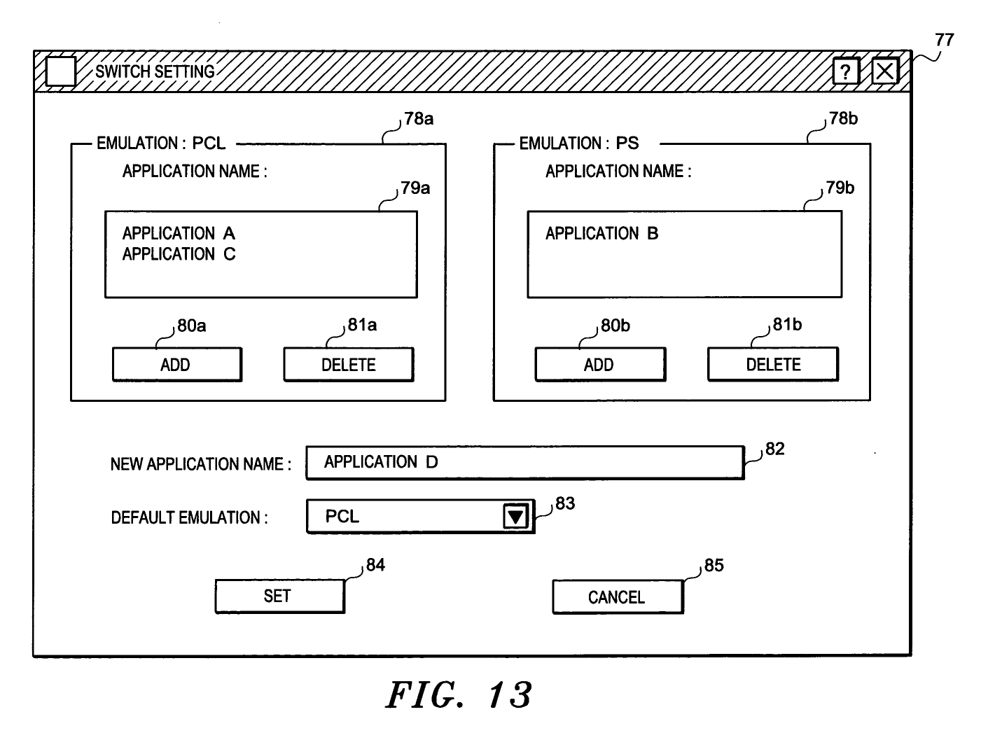

FIG. 13 is an explanation diagram of a switch setting scene displayed on a displaying section of embodiment 2.

As shown by the FIG. 13, in a switch setting scene 77, emulation group display areas 78a and 78b are displayed in a row. The respective emulation group display areas 78a and 78b correspond to respective emulations of “PCL” and “PS” supported by the printer driver unit 71.

In the emulation group display area 78a, an application name list box 79a is displayed. In the application name list box 79a, respective application names of applications registered to correspond to the emulation group, i.e. the emulation “PCL” are listed. Further, an “ADD” button 80a to add application name displayed in the application name list box 79a and a “DELETE” button 81a to delete the in order to cancel a registration of the application are provided.

Likewise, in the emulation group display area 78b, an application name list box 79b, an “ADD” button 80b and a “DELETE” button 81b are provided.

The switch setting scene 77 further has a new application name edit box 82 for inputting application name. For example, when operator inputs a desirable application name into the new application name edit box 82 via the selecting and inputting section 73 and presses the “ADD” button 80a in the emulation group display area 78a, the inputted application name is displayed in the application name list box 79a within the emulation group display area 78a.

Further, for example, when one application name displayed in the application name list box 79a is selected and the “DELETE” button 81a in the emulation group display area 78a is pressed, the application name in the application name list box 79a is deleted.

The switch setting scene 77 furthermore has a default emulation drop down list box 83 capable of displaying a list of emulations. In the default emulation drop down list box 83, the emulation names of respective emulations supported by the printer driver unit 71 are displayed one by one according to the selection of operator.

The switch setting scene 77 furthermore has a “SET” button 84 to execute a setting and a “CANCEL” button 85 to cancel the setting.

After operator performed input and selection in the switch setting scene 77, the selecting and inputting section 73 shown by the FIG. 12 outputs respective information displayed in the application name list boxes 79a, 79b and in the default emulation drop down list box 83 of the switch setting scene 77 to the selecting and setting section 76 as corresponding information.

The selecting and setting section 76 is a processing section to set the corresponding information inputted from the selecting and inputting section 73 into a corresponding information storing portion 88. The selecting and setting section 76 performs a rewriting process of inputted corresponding information with respect to a corresponding information table 92 that will be mentioned below and sets the corresponding information.

The display controlling section 75 has a function to control the displaying section 74 to display respective scenes. For example, the display controlling section 75, after received a setting request of corresponding information from the application section 72, reads out the stored corresponding information from the corresponding information storing portion 88 of the printer driver unit 71 and makes the displaying section 74 display the switch setting scene 77 (FIG. 13) on the basis of the corresponding information.

The printer driver unit 71, as shown by the FIG. 12, includes a parent driver section 86 and subsidiary driver sections 87a and 87b.

The parent driver section 86 has a corresponding information storing portion 88, a specifying portion 89, a searching and reading portion 90 and a switching portion 91.

The corresponding information storing portion 88 is a storing section to store a corresponding information table 92. The corresponding information table 92 stored in the corresponding information storing portion 88 is set by the selecting and setting section 76.

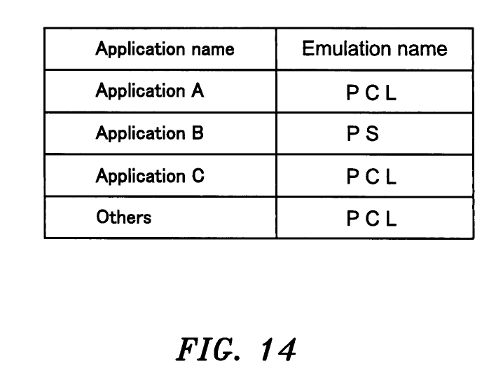

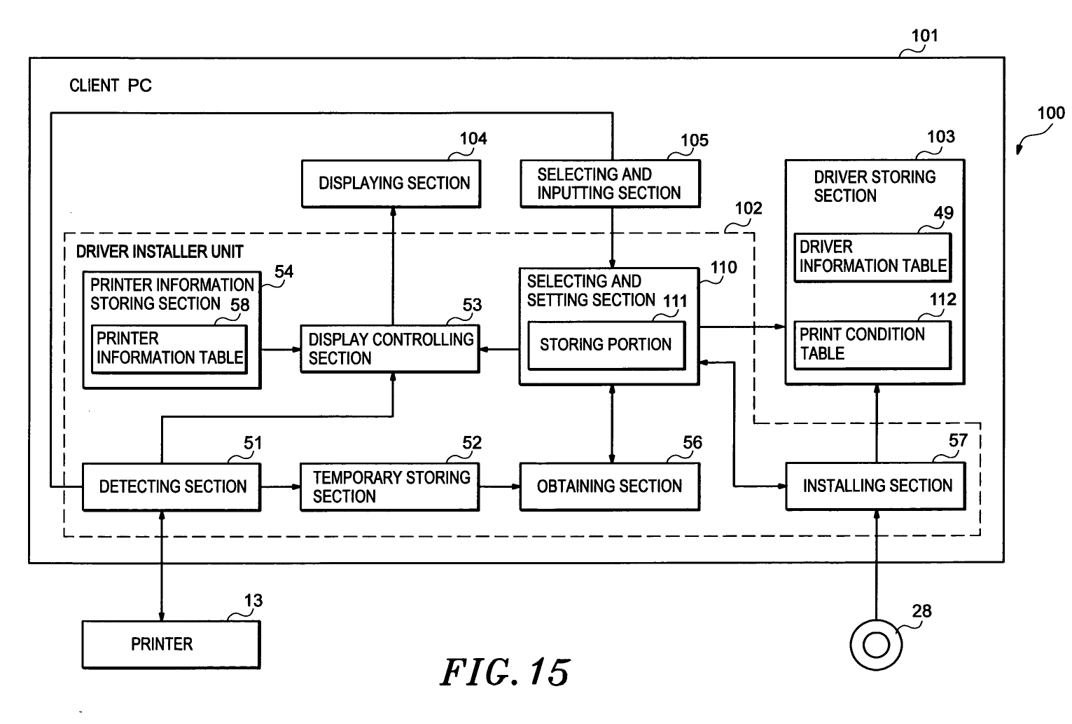

FIG. 14 is a structure diagram showing a corresponding information table of embodiment 2.

In the corresponding information table 92, as shown by the FIG. 14, corresponding information of respective application and respective emulations is stored.

For example, in the corresponding information table 92 shown by the FIG. 14, to correspond to an application name of “APPLICATION A” serving as application identification information, an emulation name of “PCL” is stored as emulation identification information. That is, with respect to such manuscript made by the application called “APPLICATION A”, the corresponding print process should use the emulation “PCL”, and the application name of “APPLICATION A” and the emulation name of “PCL” formed the corresponding information. Further, to correspond to an application name of “APPLICATION B”, an emulation name of “PS” is stored. That is, with respect to such manuscript made by the application called “APPLICATION B”, the corresponding print process should use the emulation “PS”, the application name of “APPLICATION B” and the emulation name of “PS” formed the corresponding information.

Furthermore, to correspond to an application name of “OTHERS”, an emulation name of “PCL” is stored; this indicates that default emulation is “PCL”. That is, with respect to such manuscript made by an application whose application name is not registered in the corresponding information table 92, the corresponding print process uses the emulation “PCL”, the application name of “OTHERS” and the emulation name of “PCL” formed the corresponding information. The default emulation is composed of an emulation selected in the default emulation drop down list box 83 provided in the switch setting scene 77 (FIG. 13).

The specifying portion 89 specifies an application to make the manuscript to print on the basis of a parameter contained in the print request information received from the application section 72 via the GDI, and notifies the searching and reading portion 90 of an application name of the application. Further, the specifying portion 89 sends manuscript data contained in the print request information to the switching portion 91.

The searching and reading portion 90 searches the corresponding information table 92 stored in the corresponding information storing portion 88 on the basis of the application name notified from the specifying portion 89, reads out the corresponding emulation name, and specifies the corresponding emulation used for print process. Then, the searching and reading portion 90 notifies the switching portion 91 of the emulation name.

The switching portion 91 performs a switch process on the basis of the emulation name notified from the searching and reading portion 90. For example, when received the emulation name of “PCL” from the searching and reading portion 90, the switching portion 91 performs a switch process toward the subsidiary driver section 87a corresponding to the emulation “PCL”, and sends the manuscript data received from the specifying portion 89 to the subsidiary driver section 87a.

The subsidiary driver section 87a has a printer driver function corresponding to the emulation “PCL”, and has a print condition setting portion 93a and a changing portion 94a.

The print condition setting portion 93a sets print condition information composed of respective item information such as paper size, paper feeding method and the like.

The changing portion 94a has a function to change the manuscript data into printer language corresponding to the emulation “PCL” of the printer 63 on the basis of the manuscript data received from the switching portion 91 of the parent driver section 86 and of the print condition information set by the print condition setting portion 93a, and to generate print data. Further, the changing portion 94a sends the generated print data to the printer 63.

The subsidiary driver section 87b has a printer driver function corresponding to the emulation “PS”, and has a print condition setting portion 93b and a changing portion 94b.

Next, regarding operations to change the manuscript data into print data in the client PC 61 and to execute a print process by the printer 63, they will be explained by using a flowchart shown by FIG. 11.

FIG. 11 is a flowchart showing print operation in embodiment 2 of a print processing system of the present invention.

When print instruction information is inputted via the selecting and inputting section 73, the application section 72 inputs print request information to the specifying portion 89 via the GDI (not shown) (S201).

The specifying portion 89 specifies an application making the manuscript to print on the basis of the inputted print request information (S202). Then, the specifying portion 89 notifies the searching and reading portion 90 of application name of the specified application and sends the manuscript data contained in the print request information to the switching portion 91.

The searching and reading portion 90 searches the corresponding information table 92 of the corresponding information storing portion 88 on the basis of the application name notified from the specifying portion 89, and judges whether a corresponding application name is stored or not (S203). For example, in the case that the notified application name is “APPLICATION A”, the searching and reading portion 90 judges that a corresponding application name is stored in the corresponding information table 92; in the case that the notified application name is “APPLICATION D”, the searching and reading portion 90 judges that a corresponding application name is not stored in the corresponding information table 92.

In S203, when judged that a corresponding application name is stored, the searching and reading portion 90 reads out the emulation name corresponding to the application name, and notifies the switching portion 91 of the emulation name (S204). That is, the searching and reading portion 90 is notified of the application name of “APPLICATION A”, reads out the emulation name of “PCL” from the corresponding information table 92, and notifies the switching portion 91 of it.

In S203, when judged that a corresponding application name is not stored, the searching and reading portion 90 reads out the emulation name of the default emulation from the corresponding information table 92, and notifies the switching portion 91 of the emulation name (S205). That is, in the corresponding information table 92 (FIG. 14), because the emulation name of the default emulation stored to correspond to the application name of “OTHERS” is “PCL”, the searching and reading portion 90 notifies the switching portion 91 of the emulation name of “PCL”.

The switching portion 91 notified of the emulation name performs a switch process toward the subsidiary driver section corresponding to the emulation and send manuscript data received from the specifying portion 89 to the subsidiary driver section (S206). For example, when notified of the emulation name of “PCL”, the switching portion 91 sends the manuscript data to the subsidiary driver section 87a corresponding to the emulation “PCL”.

Then, in the subsidiary driver section 87a, the changing portion 94a generate print data on the basis of the manuscript data received from the switching portion 91 and of the print condition information set by the print condition setting portion 93a (S207). Continuously, the changing portion 94a sends the generated print data to the printer 63 via spooler (S207).

Then, the printer 63 received the print data executes a print of the manuscript on the basis of the print data (S208). Thus, the print processing system 60 ended a print process.

As stated above, after a suitable emulation is automatically selected on the basis of the application making manuscript and a change from manuscript data to print data is performed by the corresponding subsidiary driver section i.e. printer driver, a print process is executed by the printer.

In the embodiment, in the print processing system, the corresponding information of the respective applications and the respective emulations to correspond to these applications is previously set in the client PC; after the application making the manuscript to print is specified while executing print process, a suitable emulation is selected and a switch process is performed toward the corresponding subsidiary driver section. Therefore, such selection work of printer driver through operator is disused, so that it is possible to prevent some unsuitable selection of printer driver and useless print process. As a result, it is possible to obtain most suitable performance of printer.

### Embodiment 3

FIG. 15 is a function block diagram showing a function structure of client PC in embodiment 3.

As shown by the FIG. 15, a client PC 101 is connected with a printer 13 via network, and constructs a print processing system 100 together with the printer 13.

In the embodiment, regarding the same composition as that in embodiments 1 and 2, a same sign will be provided and its detail explanation will be omitted.

In the a client PC 101 of the print processing system 100 shown by the FIG. 15, the driver installation program 29 (FIG. 3) read out from the CD-ROM 28 is executed and an installation of printer driver is in executable state.

As shown by the FIG. 15; the client PC 11 comprises a driver installer unit 102, a driver storing section 103, a displaying section 104 and a selecting and inputting section 105.

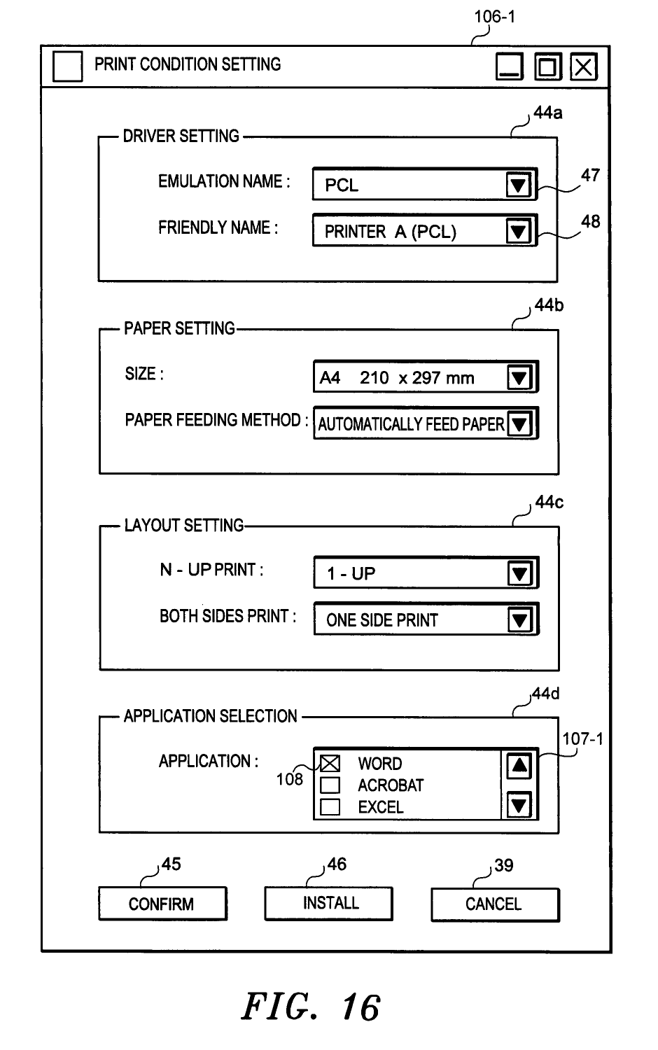

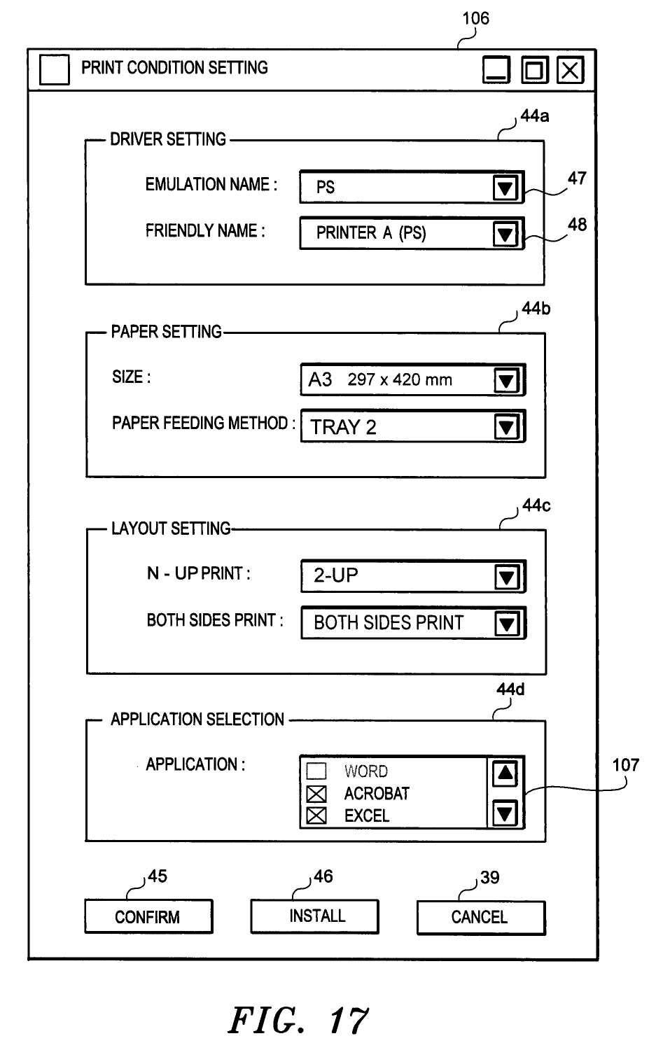

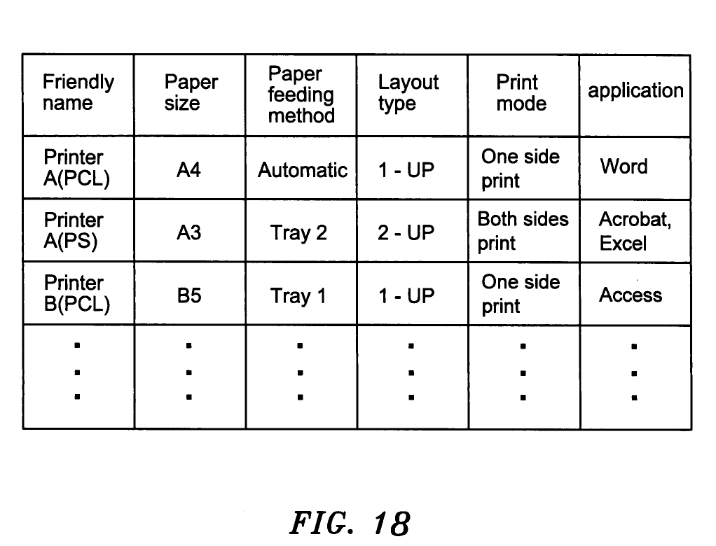

The displaying section 104 has a function to display print condition setting scene shown by FIGS. 16 and 17.

The selecting and inputting section 105 has a function to select and input print condition information of printer driver corresponding to respective emulations in the print condition setting scene shown by FIGS. 16 and 17, and to output the print condition information to the driver installer section 102.

FIG. 16 is a first explanation diagram of a print condition setting scene displayed on a displaying section of embodiment 3.

A print condition setting scene 106-1, as shown by the FIG. 16, has four parts 44a, 44b, 44c and 44d. In these parts, not only respective item information such as emulation name, paper size, paper feeding method, print mode are displayed, but also application name is displayed. Further, on the print condition setting scene 106-1, a “CONFIRM” button 45, an “INSTALL” button 46 and a “CANCEL” button 39 are respectively provided.

Regarding the parts 44a, 44b and 44c in the print condition setting scene 106-1, because their structures are the same as that in embodiment 1, their explanations are omitted.

In the print condition setting scene 106-1, the part 44d has an application name list box 107-1 which is provided for selecting and setting at least one application name to correspond to one printer driver. In the application name list box 107-1, application names of respective application that can be used in the client PC 101 are displayed as a list, and a selection button 108 is provided to correspond to the respective application name.

In the application name list box 107-1, as application capable of being used in the client PC 101, application names of “Word”, “Acrobat” and “Excel” are displayed, and the application name of “Word” is selected by the selection button 108. That is, as the application corresponding to the emulation name of “PCL”, the application “Word” is set. Regarding the information relative to the usable application, when installer operates, the installer can obtain it from the client PC 101.

FIG. 17 is a second explanation diagram of a print condition setting scene displayed on a displaying section of embodiment 3.

After the print condition information is set in the print condition setting scene 106-1 with respect to the printer driver corresponding to the emulation name of “PCL”, in the case to set other print condition information with respect to the other printer driver i.e. the printer driver corresponding to the emulation name of “PS”, as shown by the FIG. 17, a print condition setting scene 106-2 is displayed on the displaying section 104. In the part 44d of the print condition setting scene 106-2, an application name list box 107-2 is provided. In the application name list box 107-2, with respect to the application which has been selected in the print condition setting scene 106-1, its corresponding selection button 108 is set to be un-selectable. That is, because the application “Word” corresponding to the emulation name of “PCL” is selected in the print condition setting scene 106-1, in the application name list box 107-2 of the print condition setting scene 106-2, the selection button 108 corresponding to the application name of “Word” becomes un-selectable (grayed out display).

The driver storing section 103 is a storing section to store the printer driver program 30 constructing printer driver installed by the driver installer unit 102, driver information, print condition information and the like. As shown by the FIG. 15, the driver storing section 103 includes a driver information table 49 (FIG. 8) and a print condition table 112.

FIG. 18 is a structure diagram showing a print condition table of embodiment 3.

In the print condition table 112, as shown by the FIG. 18, print condition information of each printer driver is stored to correspond to friendly name serving as printer driver ID.

In the embodiment, the print condition information stored in the print condition table 112 is not only composed of respective item information of paper size, paper feeding method, layout type and print mode; but also composed of an application name.

For example, in the print condition table 112 shown by FIG. 18, to correspond to the friendly name of “Printer A (PCL)”, paper size “A4”; paper feeding method “Automatic”; layout type “1-UP”; print mode “One side print” and application name “word” are stored.

Further, to correspond to the friendly name of “Printer A (PS)”, paper size “A3”; paper feeding method “Tray 2”; layout type “2-UP”; print mode “Both sides print” and application names “Acrobat” and “Excel” are stored.

The driver installer unit 102 includes a detecting section 51; a temporary storing section 52; a display controlling section 109; a printer information storing section 54; a selecting and setting section 110, an obtaining section 56; and an installing section 57.

The display controlling section 109 has a function to control the displaying section 104 to display respective scenes including the print condition setting scenes 106-1 and 106-2 (FIGS. 16 and 17).

The selecting and setting section 110 is a processing section to perform settings of driver information and print condition information to correspond to respective printer drivers and to make the driver storing section 103 store the driver information and the print condition information, the selecting and setting section 110 has a storing portion 111. The storing portion 111 is a temporary storing portion to temporarily store the driver information and the print condition information inputted by the selecting and inputting section 105.

The following is to explain in detail installation process in the client PC 11 to install printer driver according to a flowchart.

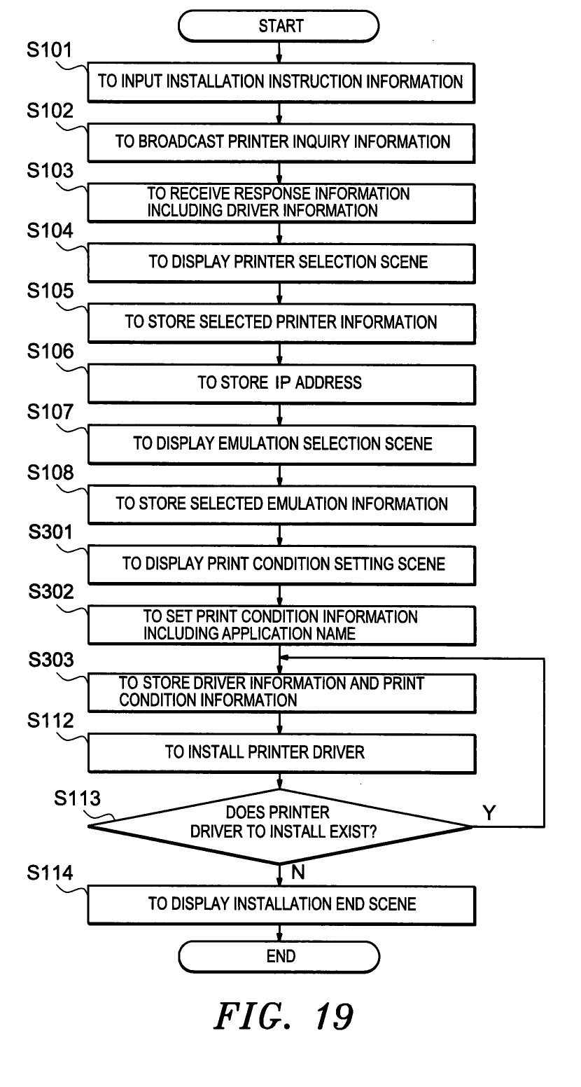

FIG. 19 is a flowchart showing printer driver installation operation in embodiment 3 of a client PC of the present invention.

In the client PC 101, because these processes from the step (S101) that the selecting and inputting section 105 inputs the installation instruction information to the step (S108) that the selecting and setting section 110 stores the emulation name into the storing portion 111 as selection emulation information are the same as that in embodiment 1, their explanations are omitted.

After the selection emulation information is stored (S108), the selecting and setting section 110 notifies the display controlling section 109 of the selection emulation information. The display controlling section 109 receives the notification and controls the displaying section 104 to display the print condition setting scene 106-1 shown by FIG. 16 (S301).

Through using the print condition setting scene 106-1, operator makes the drop down list box 47 display one selection emulation information; inputs friendly name in the edit box 48 to correspond to the selection emulation information in the drop down list box 47; then respectively selects and sets the paper size, the paper feeding method, the layout type and the print mode (S302). Further, operator selects the selection button 108 corresponding to one application name in the application name list box 107-1 so as to set application name (S302). When the “CONFIRM” button 45 is pressed, the selecting and inputting section 105 outputs the respective item information of the friendly name, the paper size, the paper feeding method, the layout type, the print mode and application name that serve as print condition information to the selecting and setting section 110 together with the emulation name. The selecting and setting section 110 receives an input of the selecting and inputting section 105, and stores the print condition information containing application name into the storing portion 111 to correspond to the emulation name.

For example, in the print condition setting scene 106-1 (FIG. 16), in the state that the emulation name of “PCL” is displayed in the drop down list box 47, when the friendly name of “PRINTER A (PCL)” is inputted in the edit box 48; the paper size of “A4”, the paper feeding method of “AUTOMATICALLY FEED PAPER”, the layout type of “1-UP”, the print mode of “ONE SIDE PRINT” and the application name “Word” are selected and set; and the “CONFIRM” button 45 is pressed, the selecting and setting section 110 stores the respective item information of the friendly name of “PRINTER A (PCL)”, the paper size of “A4”, the paper feeding method of “AUTOMATICALLY FEED PAPER”, the layout type of “1-UP”, the print mode of “ONE SIDE PRINT” and the application name “Word” into the storing portion 111 as the print condition information to correspond to the emulation name of “PCL”.

Continuously, the print condition setting scene 106-2 (FIG. 17) is displayed on the displaying section 104. When operator makes the drop down list box 47 of the print condition setting scene 106-2 display the emulation name of “PS”, in the application name list box 107-2, as shown by FIG. 17, the application names of “Acrobat” and “Excel” and their corresponding selection buttons 108 are displayed. Moreover, because the selection button 108 corresponding to the application name “Word” has been selected in the print condition setting scene 106-1 to correspond to the emulation “PCL”, in the print condition setting scene 106-2, it is un-selectable.

In the print condition setting scene 106-2, in the state that the emulation name of “PS” is displayed in the drop down list box 47, when the friendly name of “PRINTER A (PS)” is inputted; the paper size of “A3”, the paper feeding method of “TRAY 2”, the layout type of “2-UP”, the print mode of “BOTH SIDES PRINT” and the application names of “Acrobat” and “Excel” are selected and set; and the “CONFIRM” button 45 is pressed, the selecting and setting section 110 stores the respective item information of the friendly name of “PRINTER A (PS)”, the paper size of “A3”, the paper feeding method of “TRAY 2”, the layout type of “2-UP”, the print mode of “BOTH SIDES PRINT” and the application names of “Acrobat” and “Excel” into the storing portion 111 as the print condition information to correspond to the emulation name of “PS”.

After the print condition information is set with respect to the respective emulations (S302), when the “INSTALL” button 46 is pressed in the print condition setting scene, the selecting and setting section 110 receives the input of the selecting and inputting section 105 and has the driver storing section 103 store the driver information and the print condition information corresponding the respective friendly names stored in the storing portion 111 (S303).

Further, Then, the installing section 57 performs an installation toward the driver storing section 103 of the printer driver program 30 on the basis of an input of the selecting and setting section 110 (S112). Because the following processes are the same as that in the embodiment 1, their explanations are omitted. In the client PC 101, when the displaying section 104 displays an installation end scene (S114). The printer driver installation process in the print processing system 100 ended.

As stated above, in the print processing system of the embodiment, while collectively installing the printer drivers corresponding to the respective emulations, the application used in the client PC is also set to correspond to the suitable emulation, so it is possible to further improve the efficiency of installation.

The present invention is not limited to the foregoing embodiments but many modifications and variations are possible within the spirit and scope of the appended claims of the invention.

What is claimed is:

1. A driver installing method to install respective driver programs corresponding to plural modes to a terminal apparatus in order to drive a device serving as peripheral equipment, comprising steps of:
inputting device information for specifying said device;
selecting said plural modes corresponding to said device on the basis of said device information; and
collectively installing said respective driver program corresponding to said plural modes to said terminal apparatus.

2. The driver installing method according to claim 1,
wherein said device information includes an address of said device.

3. The driver installing method according to claim 1,
wherein said device information includes a device name of said device.

4. The driver installing method according to claim 1,
wherein said inputting step is realized through previously obtaining said device information from said device.

5. The driver installing method according to claim 4,
wherein said device information includes an address of said device.

6. The driver installing method according to claim 4,
wherein said device information includes a device name of said device.

7. The driver installing method according to claim 4,
wherein said device is composed of a printing apparatus;
said plural modes are composed of plural emulations;
said driver program is composed of a printer driver program to change manuscript data make in said terminal apparatus into print data to correspond to one of said plural emulations;
said selecting step is to select said plural emulations; and
said installing step is to install said printer driver programs corresponding to selected respective emulations.

8. The driver installing method according to claim 7, further comprising a step of:
setting print condition information indicating print condition of said print data to correspond to said respective emulations,
wherein said installing step is to install on the basis of said print condition information.

9. A terminal apparatus capable of installing respective driver programs corresponding to plural modes in order to drive a device serving as peripheral equipment, comprising:
an inputting section for inputting device information for specifying said device;
a selecting section for selecting said plural modes corresponding to said device on the basis of said device information; and
an installing section for collectively installing said respective driver program corresponding to said plural modes.

10. A driver controlling method for performing a control of respective drivers in a terminal apparatus in which said respective drivers are installed to correspond to plural emulations set in a printing apparatus, comprising steps of:
previously storing application identification information of application to correspond to emulation identification information of said emulation;
deciding application to make manuscript data;
selecting said emulation to correspond to said application and specifying driver corresponding to said emulation; and
changing said manuscript data into print data by said specified driver.

11. A terminal apparatus in which respective drivers are installed to correspond to plural emulations set in a printing apparatus, comprising:
a storing section for previously storing application identification information of application to correspond to emulation identification information of said emulation;
a deciding section for deciding application to make manuscript data;
a searching and reading section for searching said storing section on the basis of said application identification information of said decided application, and reads out said corresponding emulation identification information;
a specifying section for specifying a corresponding driver on the basis of said read emulation identification information; and
a changing section for changing said manuscript data into print data by said specified driver.
